(19) United States
(12) Patent Application Publication
(10) Pub. No.: US 2023/0351511 A1
(43) Pub. Date: Nov. 2, 2023

(54) COMPUTER-IMPLEMENTED CURRENCY EXCHANGE METHOD

(71) Applicant: QARASOFT INC., Seoul (KR)

(72) Inventor: Changhwan BYUN, Seoul (KR)

(21) Appl. No.: 18/347,897

(22) Filed: Jul. 6, 2023

Related U.S. Application Data
(63) Continuation of application No. PCT/KR2021/015792, filed on Nov. 3, 2021.

(30) Foreign Application Priority Data
Jan. 28, 2021 (KR) 10-2021-0012471

(51) Int. Cl. G06Q 40/04

(52) U.S. Cl. CPC G06Q 40/04

(57) ABSTRACT

A method for exchanging currency of one country for foreign currency includes sorting blocks which are generated based on a net buying amount of foreign currency of each user on a reference date in accordance with a predetermined order; sorting blocks which are generated based on a net selling amount of foreign currency of each user on the reference date in accordance with a predetermined order; determining whether Difference 1 can be sold with a trust property when Sum 1 is greater than Sum 2; performing a self-exchange to Block 1 and Block 2 if it is determined that Difference 1 can be sold with a trust property; determining whether Difference 2 can be bought with the trust property; and performing a market-exchange to Block 1 and performing the self-exchange to Block 2 if it is determined that Difference 2 can be bought with the trust property.

### CROSS-REFERENCE TO RELATED APPLICATION

This application is a continuation application of International Application No. PCT/KR2021/015792 filed on Nov. 3, 2021, which claims priority to Korean Application No. 10-2021-0012471 filed on Jan. 28, 2021. The aforementioned applications are incorporated herein by reference in their entireties.

### TECHNICAL FIELD

The present disclosure relates to a computer-implemented currency exchange method, more specifically, a method for exchanging currency of one country for currency of another country with minimum exchange fees.

### RELATED ART

Many securities firms provide services for buying or selling foreign stocks. For the transactions of foreign stocks, local currency should be exchanged for the currency of the country where the foreign stocks are listed, or vice versa. That is, foreign stock transactions inevitably accompany currency exchange processes.

In order to buy foreign stocks, currency exchange is carried out; an order to buy foreign stocks is placed; and then payment for stock purchase is made in the foreign currency, a few days later, for example, two days later in the time of the foreign country. When foreign stocks are sold, the proceeds from stock sales are received in foreign currency after a few days, for example, two days, and thereafter the foreign currency is exchanged for the currency of the stockholder's country.

In these processes, exchange fees are incurred twice in buying foreign stocks and selling foreign stocks, thereby causing excessive amount of fees.

### SUMMARY

The object of the present disclosure is to provide a computer-implemented method for exchanging currency of one country for foreign currency. According to one aspect of the present disclosure which can be applied in Situation 1 as will be defined in below, the method comprises a first step of sorting blocks which are generated based on a net buying amount of foreign currency of each user on a reference date in accordance with a predetermined order; a second step of sorting blocks which are generated based on a net selling amount of foreign currency of each user on the reference date in accordance with a predetermined order; a third step of determining whether Difference 1 can be sold with a trust property when Sum 1 is greater than Sum 2; a fourth step of performing a self-exchange to Block 1 and Block 2 if it is determined that Difference 1 can be sold with a trust property; a fifth step of determining whether Difference 2 can be bought with the trust property; and a sixth step of performing a market-exchange to Block 1 and performing the self-exchange to Block 2 if it is determined that Difference 2 can be bought with the trust property.

Sum 1 is a total sum of the net buying amount of foreign currency for each user and Sum 2 is a total sum of the net selling amount of foreign currency for each user.

Block 2 is the last block among the blocks of the net selling amount of foreign currency and Block 1 is the block of the net buying amount of foreign currency, which overlaps with Block 2.

Sum 3 is the sum of the blocks up to Block 1 and Sum 4 is the sum of the blocks which are positioned before Block 1.

Difference 1 is the difference between Sum 3 and Sum 2, and Difference 2 is the difference between Sum 2 and Sum 4.

According to one aspect of the present disclosure which can be applied in Situation 2 as will be defined in below, the method comprises a first step of sorting blocks which are generated based on a net buying amount of foreign currency of each user on a reference date in accordance with a predetermined order; a second step of sorting blocks which are generated based on a net selling amount of foreign currency of each user on the reference date in accordance with a predetermined order; a third step of determining whether Difference 3 can be sold with a trust property when Sum 1 is less than Sum 2; a fourth step of performing a self-exchange to Block 1 and requesting a market-exchange to Block 2 if it is determined that Difference 3 can be sold with a trust; a fifth step of determining whether Difference 4 can be bought with the trust property; and a sixth step of performing the self-exchange to Block 1 and Block 2 if it is determined that Difference 2 can be bought with the trust property.

In Situation 2, Block 1 is the last block among the blocks of the net buying amount of foreign currency and Block 2 is the block of the net selling amount of foreign currency, which overlaps with Block 1. Sum 5 is the sum of the blocks which are positioned before Block 2 and Sum 6 is the sum of the blocks up to Block 2. Difference 3 is the difference between Sum 1 and Sum 5, and Difference 4 is the difference between Sum 6 and Sum 1.

The predetermined order is a descending order based on the net buying amount of foreign currency and the absolute value of the net selling amount of foreign currency.

In Situation 1, the method can further comprise a seventh step of performing the self-exchange to the blocks which are positioned before Block 1 and the blocks which are positioned before Block 2 and performing the market-exchange to the blocks after Block 1.

In Situation 2, the method can further comprise a seventh step of performing the self-exchange to the blocks which are positioned before Block 1 and the blocks which are positioned before Block 2 and performing the market-exchange to the blocks after Block 2.

The third step is performed before the fifth step.

The self-exchange for buying foreign currency and selling foreign currency is performed at the same time and the market-exchange for buying foreign currency is performed before the market-exchange for selling foreign currency.

In Situation 1, if it is determined that Difference 1 cannot be sold with a trust property the market-exchange is performed to Block 1 and Block 2.

In Situation 2, if it is determined that Difference 3 cannot be sold with a trust property the market-exchange is performed to Block 1 and Block 2.

The present disclosure can be embodied in a computer program product comprising one or more non-transitory computer-readable storage media and program instructions stored in at least one of the non-transitory computer-readable storage media, the program instructions being executable by a processor to cause the processor to perform the above method.

The present disclosure can be embodied in a computer-implemented system comprising one or more processors and one or more non-transitory computer readable storage media storing computer-executable instructions that, when executed, cause the one or more processors to perform the method of the present disclosure.

### BRIEF DESCRIPTION OF THE DRAWINGS

FIG. 1 is a conceptual drawing for explaining currency exchange in Situation 1 according to the present disclosure;

FIG. 2 is a conceptual drawing for explaining currency exchange in Situation 2 according to the present disclosure;

FIG. 3 is a flow chart of the currency exchange method in Situation 1 according to the present disclosure;

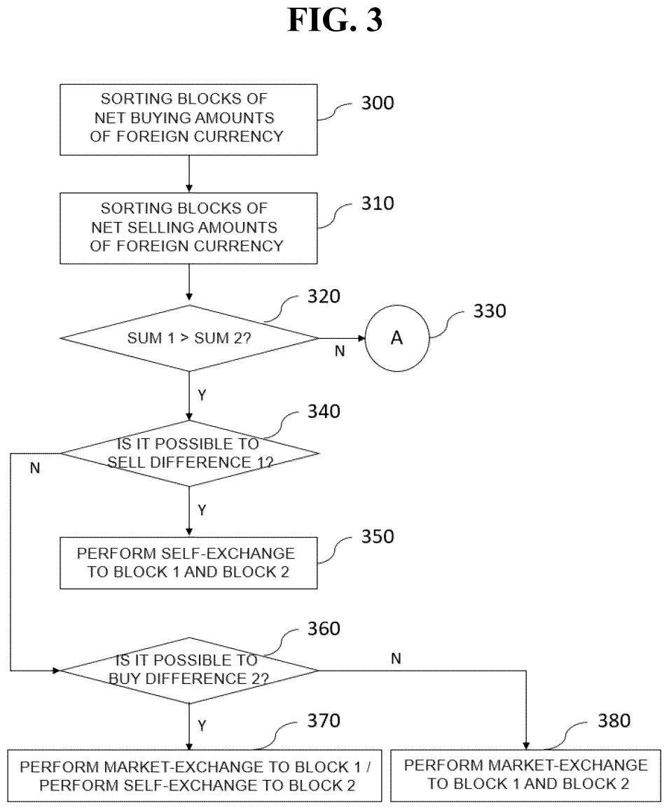

FIG. 4 is a flow chart of the currency exchange method in Situation 2 according to the present disclosure;

FIG. 5 is an exemplary block diagram of electronic arithmetic device carrying out the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

In this specification, the order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” or “include” has a meaning of further including other components in addition to the components listed.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise,” “include” and/or “comprising,” “including” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled,” “connect” and the like denotes a physical relationship between two components whereby the components are either directly connected to one another or indirectly connected via one or more intermediary components.

The term “module” or “unit” means a logical combination of a universal hardware and a software carrying out required function.

In this specification, the essential elements for the present disclosure will be described and the non-essential elements may not be described. However, the scope of the present disclosure should not be limited to the invention including only the described components. Further, it should be understood that the invention which includes additional elements or does not have non-essential elements can be within the scope of the present disclosure.

The method of the present disclosure can be carried out by an electronic arithmetic device such as a computer, tablet, mobile phone, portable computing device, stationary computing device, server computer, etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

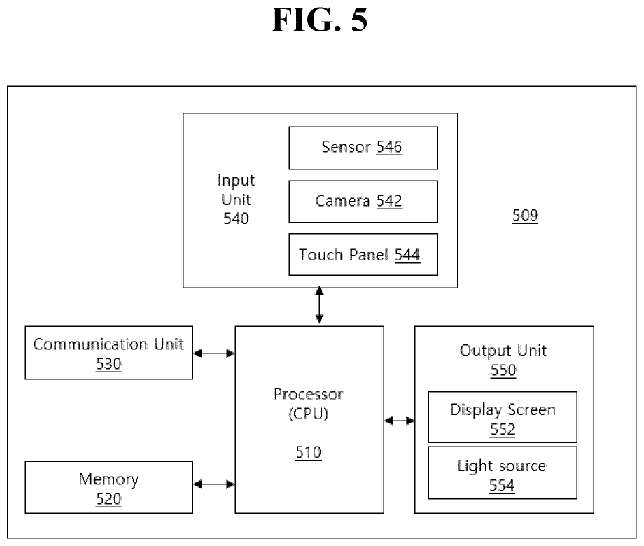

A variety of devices can be used herein. FIG. 5 illustrates an example diagrammatic view of an exemplary device architecture according to embodiments of the present disclosure. As shown in FIG. 5, a device (509) may contain multiple components, including, but not limited to, a processor (e.g., central processing unit (CPU); 510), a memory (520; also referred to as “computer-readable storage media”), a wired or wireless communication unit (530), one or more input units (540), and one or more output units (550). It should be noted that the architecture depicted in FIG. 5 is simplified and provided merely for demonstration purposes. The architecture of the device (509) can be modified in any suitable manner as would be understood by a person having ordinary skill in the art, in accordance with the present claims. Moreover, the components of the device (509) themselves may be modified in any suitable manner as would be understood by a person having ordinary skill in the art, in accordance with the present claims. Therefore, the device architecture depicted in FIG. 5 should be treated as exemplary only and should not be treated as limiting the scope of the present disclosure.

The processor (510) is capable of controlling the operation of the device (509). More specifically, the processor (510) may be operable to control and interact with multiple components installed in the device (509), as shown in FIG. 5. For instance, the memory (520) can store program instructions that are executable by the processor (510) and data. The process described herein may be stored in the form of program instructions in the memory (520) for execution by the processor (510). The communication unit (530) can allow the device (509) to transmit data to and receive data from one or more external devices via a communication network. The input unit (540) can enable the device (509) to receive input of various types, such as audio/visual input, user input, data input, and the like. To this end, the input unit (540) may be composed of multiple input devices for accepting input of various types, including, for instance, one or more cameras (542; i.e., an “image acquisition unit”), touch panel (544), microphone (not shown), sensors (546), keyboards, mice, one or more buttons or switches (not shown), and so forth. The term “image acquisition unit,” as used herein, may refer to the camera (542), but is not limited thereto. The input devices included in the input (540) may be manipulated by a user. The output unit (550) can display information on the display screen (552) for a user to view. The display screen (552) can also be configured to accept one or more inputs, such as a user tapping or pressing the screen (552), through a variety of mechanisms known in the art. The output unit (550) may further include a light source (554). The device (509) is illustrated as a single component, but the device may also be composed of multiple, separate components that are connected together and interact with each other during use.

The terms “first,” “second,” or the like are herein used to distinguishably refer to same or similar elements, or the steps of the present disclosure and they may not infer an order or a plurality.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In this specification, the amount of foreign currency to be bought is indicated with “+”, and the amount of foreign currency to be sold is indicated with “−”.

For example, if a user places an order to sell $100 worth (−100) of stocks of Company A and to buy $100 worth (+100) of stocks of Company B, the net amount of foreign currency for the stock transaction is 0 (zero).

If a user places an order to sell $100 worth (−100) of stocks of Company A and to buy $80 worth (+80) of stocks of Company B, the net amount of foreign currency for the stock transaction is −20, which is also referred to as a net selling amount of foreign currency.

If a user places an order to sell $80 worth (−80) of stocks of Company A and to buy $100 worth (+100) of stocks of Company B, the net amount of foreign currency for the stock transaction is +20, which is also referred to as a net buying amount of foreign currency.

According to the present disclosure, the net amount of foreign currency for each user is calculated by collecting orders to buy and sell foreign stocks on a specific reference date. Thereafter, the users are divided into the users having the net buying amount of foreign currency and the users having the net selling amount of foreign currency.

In the step (300), the net buying amounts of foreign currency of each user are sorted according to the amount. In the step (310), the net selling amounts of foreign currency of each user are sorted according to the absolute value of the amount. Each amount is illustrated as a block having the size corresponding to the amount. The sorting order can be descending order or ascending order with reference to the amount. The sorting order can be random, or an order based on the time when the order for buying or selling the stocks is placed. If the amounts are sorted in descending order, the self-exchange which will be described below can preferentially be applied to the block of the larger amount of foreign currency.

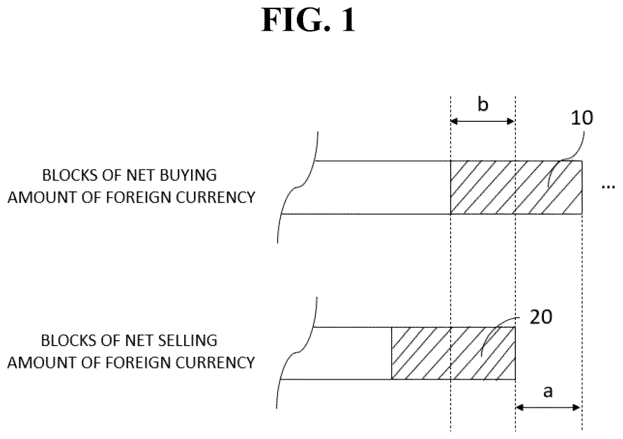

FIG. 1 is a drawing for explaining the method for carrying out foreign currency exchange in “Situation 1” in accordance with the present disclosure. In this specification, “Situation 1” is defined as the situation where the total sum of the net buying amounts of foreign currency is greater than the total sum of the net selling amounts of foreign currency. The total sum of the net buying amounts of foreign currency is referred to as “Sum 1.” The total sum of the net selling amounts of foreign currency is referred to as “Sum 2.”

In the step (320), Sum 1 and Sum 2 are compared with each other. If Sum 1 is greater than Sum 2, the step (340) is performed. Otherwise, the step (330) is performed.

The last block (20; referred to as “Block 2”) of the net selling amount of foreign currency is compared with the block (10; referred to as “Block 1”) which is overlapped with the block (20). In the step (340), it is determined whether the difference (a) between the sum up to Block 1 (10) and Sum 2 can be sold with a trust property. The difference (a) is referred to as “Difference 1.”

If it is determined that the foreign currency of Difference 1 can be sold with the trust property, the order to sell Difference 1 is executed with the trust property. Thereafter, in the step (350), the self-exchange is carried out for Block 1 (10) and Block 2 (20).

According to the present disclosure, the self-exchange can be carried out for the blocks which are positioned before Block 1 (10) and the blocks which are positioned before Block 2 (20).

If it is determined that the foreign currency of Difference 1 cannot be sold with the trust property, the process goes to the step (360). In the step (360), it is determined whether the difference (b) between Sum 2 and the sum of the amounts of the blocks which are positioned before Block 1 (10) can be bought with the trust property. The difference (b) is referred to as “Difference 2.”

If it is determined that the foreign currency of Difference 2 can be bought with the trust property, the order to buy the foreign currency of Difference 2 is executed with the trust property. Thereafter, in the step (370), the market-exchange is carried out for Block 1 (10), and the self-exchange is carried out for Block 2 (20)

If it is determined that Difference 2 cannot be bought with the trust property, in the step (380), the market-exchange is carried out for Block 1 (10) and Block 2 (20).

According to the present disclosure, the self-exchange can be carried out with the trust property having accounts of foreign currency and local currency.

If the net buying amount of foreign currency of User 1 is $100 and the self-exchange is carried out, the local currency for buying $100 is transferred to the local currency account of the trust property from the User 1's account and $100 is transferred to the User 1's account from the dollar account of the trust property.

If the net selling amount of foreign currency of User 1 is $100 and the self-exchange is carried out, $100 is transferred to the dollar account of the trust property from the User 1's account and the local currency corresponding to the amount obtained by selling $100 is transferred to the User 1's account from the local currency account of the trust property.

In the self-exchange, the amount of currency is transferred between the user's account and the account of the trust property. Therefore, there is no currency exchange in the market and there is no fee incurred in the market-exchange.

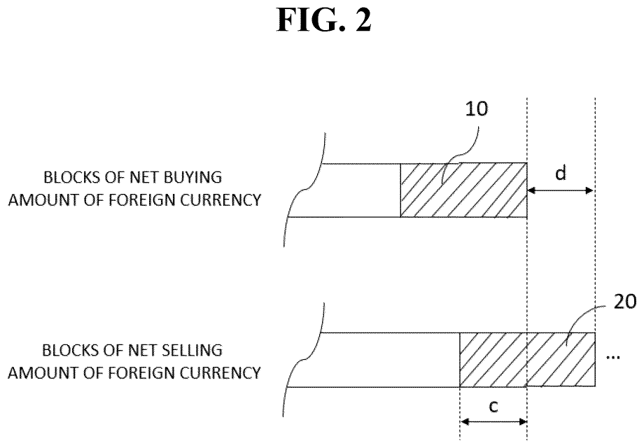

FIG. 2 is a drawing for explaining the method for carrying out foreign currency exchange in “Situation 2” in accordance with the present disclosure. In this specification, “Situation 2” is defined as the situation where Sum 1 is not greater than Sum 2.

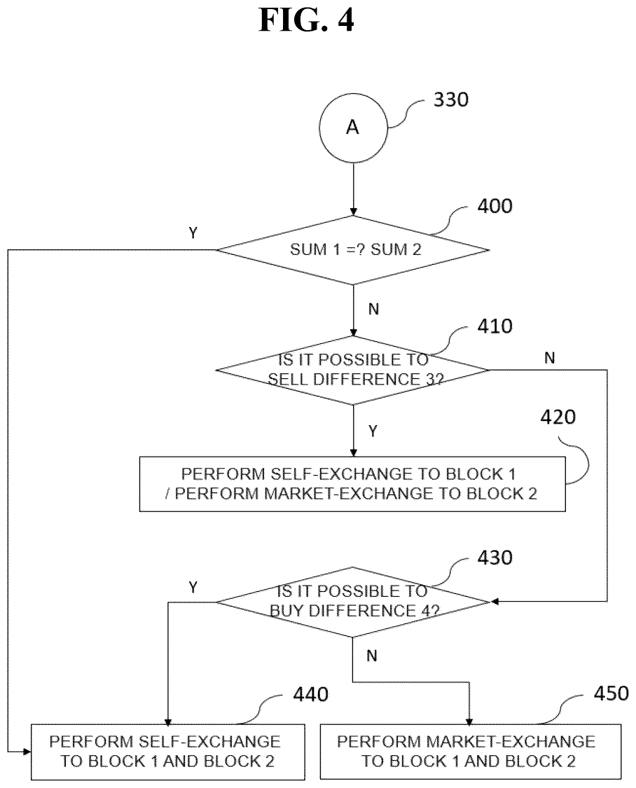

If the determination result in the step (320) is “NO,” the step (330; A) is carried out. The steps following the step (330) are illustrated in FIG. 4.

In the step (400), it is determined whether Sum 1 is equal to Sum 2.

If it is determined that Sum 1 is equal to Sum 2, the self-exchange is performed for Block 1 (10) and Block 2 (20) in the step (440). Further, the self-exchange is performed for the rest of the blocks.

If it is determined that Sum 1 is not equal to Sum 2, i.e., if Sum 1 is less than Sum 2, the step (410) is carried out.

Block 1 (10) is compared with Block 2 (20), which is overlapped with Block 1 (10). It is determined whether the difference (c) between the sum up to Block 1 (10) and the sum of the blocks which are positioned before Block 2 (20) can be sold with the trust property. The difference (c) is referred to as “Difference 3.”

If it is determined that the foreign currency of Difference 3 can be sold with the trust property, the order to sell Difference 3 is executed with the trust property. Thereafter, in the step (420), the self-exchange is carried out for Block 1 (10) and the market-exchange is performed for Block 2 (20).

If it is determined that the foreign currency of Difference 3 cannot be sold with the trust property, the process proceeds to the step (430). In the step (430), it is determined whether the difference (d) between Sum 1 and the sum of the amounts of the blocks up to Block 2 (20) can be bought with the trust property. The difference (d) is referred to as “Difference 4.”

If it is determined that the foreign currency of Difference 4 can be bought with the trust property, the order to buy Difference 4 is executed with the trust property. Thereafter, in the step (440), the self-exchange is carried out for Block 1 (10) and Block 2 (20). If it is determined that Difference 4 cannot be bought with the trust property, in the step (450), the market-exchange is carried out for Block 1 (10) and Block 2 (20).

For example, the performing time of the self-exchange and the market-exchange can be designated as follows. The date when the order is placed is defined as a reference date (T; “T” is local time.)

[In Case of Request for Net Buying Foreign Currency]

(1) Self-Exchange Time
Execution Time: T+1 PM 5:30
Payment Time: T+3 PM 3:30

(2) Market-Exchange Time
Execution Time: T+1 PM 5:30
Payment Time: T+2 AM 9:00

[In Case of Request for Net Selling Foreign Currency]

(1) Self-Exchange Time
Execution Time: T+1 PM 5:30
Payment Time: T+3 PM 3:30

(2) Market-Exchange Time
Execution Time: T+3 PM 5:30 (This execution date shall be the local date which corresponds to the midnight of the foreign date which is calculated by adding two business days to the foreign date which corresponds to the reference date (T).)
Payment Time: Execution Time+1 business day of local time, AM 9:00

According to the above example, the self-exchange carries out selling and buying the foreign currency at the same time and the market-exchange carries out execution and payment of buying the foreign currency before the execution and payment of selling the foreign currency.

According to the self-exchange of the present disclosure, foreign currency exchange can be carried out with no exchange fees. An entity that brokers the currency exchange can take the exchange rate difference as a brokerage fee. The entity can pay an additional fee for market-exchange.

According to the present disclosure, the determination of whether foreign currency can be sold with the trust property can be carried out before the determination of whether foreign currency can be bought with the trust property is carried out. This procedure can reduce the risk caused due to variation of exchange rate. However, it should be understood that the scope of the present disclosure is not limited to the determination order.

The exchange method of the present disclosure can be applied to the other field that requires that the currency of one country be exchanged for the currency of another country. For example, the present disclosure can be applied to a service that provides foreign currency exchange on the day following a request for exchange.

Although the present disclosure has been described with reference to accompanying drawings, the scope of the present disclosure is determined by the claims described below and should not be interpreted as being restricted by the embodiments and/or drawings described above. It should be clearly understood that improvements, changes, and modifications of the present disclosure disclosed in the claims and apparent to those skilled in the art also fall within the scope of the present disclosure. Accordingly, this description is to be taken only by way of example and not to otherwise limit the scope of the embodiments herein.

What is claimed is:

1. A computer-implemented method for exchanging currency of one country for foreign currency, the method comprising:
a first step of sorting blocks which are generated based on a net buying amount of foreign currency of each user on a reference date in accordance with a predetermined order;
a second step of sorting blocks which are generated based on a net selling amount of foreign currency of each user on the reference date in accordance with a predetermined order;
a third step of determining whether Difference 1 can be sold with a trust property when Sum 1 is greater than Sum 2;
a fourth step of performing a self-exchange to Block 1 and Block 2 if it is determined that Difference 1 can be sold with a trust property;
a fifth step of determining whether Difference 2 can be bought with the trust property; and
a sixth step of performing a market-exchange to Block 1 and performing the self-exchange to Block 2 if it is determined that Difference 2 can be bought with the trust property,
wherein Sum 1 is a total sum of the net buying amount of foreign currency for each user and Sum 2 is a total sum of the net selling amount of foreign currency for each user; Block 2 is the last block among the blocks of the net selling amount of foreign currency and Block 1 is the block of the net buying amount of foreign currency, which overlaps with Block 2; Sum 3 is the sum of the blocks up to Block 1 and Sum 4 is the sum of the blocks which are positioned before Block 1; and Difference 1 is the difference between Sum 3 and Sum 2, and Difference 2 is the difference between Sum 2 and Sum 4.

2. A computer-implemented method for exchanging currency of one country for foreign currency, the method comprising:
a first step of sorting blocks which are generated based on a net buying amount of foreign currency of each user on a reference date in accordance with a predetermined order;
a second step of sorting blocks which are generated based on a net selling amount of foreign currency of each user on the reference date in accordance with a predetermined order;
a third step of determining whether Difference 3 can be sold with a trust property when Sum 1 is less than Sum 2;
a fourth step of performing a self-exchange to Block 1 and requesting a market-exchange to Block 2 if it is determined that Difference 3 can be sold with a trust;
a fifth step of determining whether Difference 4 can be bought with the trust property; and
a sixth step of performing the self-exchange to Block 1 and Block 2 if it is determined that Difference 2 can be bought with the trust property,
wherein Sum 1 is a total sum of the net buying amount of foreign currency for each user and Sum 2 is a total sum of the net selling amount of foreign currency for each user; Block 1 is the last block among the blocks of the net buying amount of foreign currency and Block 2 is the block of the net selling amount of foreign currency, which overlaps with Block 1; Sum 5 is the sum of the blocks which are positioned before Block 2 and Sum 6 is the sum of the blocks up to Block 2; and Difference 3 is the difference between Sum 1 and Sum 5, and Difference 4 is the difference between Sum 6 and Sum 1.

3. The method according to claim 1, wherein the predetermined order is descending order based on the net buying amount of foreign currency and the absolute value of the net selling amount of foreign currency.

4. The method according to claim 2, wherein the predetermined order is descending order based on the net buying amount of foreign currency and the absolute value of the net selling amount of foreign currency.

5. The method according to claim 1, further comprising a seventh step of performing the self-exchange to the blocks which are positioned before Block 1 and the blocks which are positioned before Block 2 and performing the market-exchange to the blocks after Block 1.

6. The method according to claim 2, further comprising a seventh step of performing the self-exchange to the blocks which are positioned before Block 1 and the blocks which are positioned before Block 2 and performing the market-exchange to the blocks after Block 2.

7. The method according to claim 1, wherein the third step is performed before the fifth step.

8. The method according to claim 2, wherein the third step is performed before the fifth step.

9. The method according to claim 5, wherein the self-exchange for buying foreign currency and selling foreign currency is performed at the same time and the market-exchange for buying foreign currency is performed before the market-exchange for selling foreign currency.

10. The method according to claim 6, wherein the self-exchange for buying foreign currency and selling foreign currency is performed at the same time and the market-exchange for buying foreign currency is performed before the market-exchange for selling foreign currency.

11. The method according to claim 1, wherein if it is determined that Difference 1 cannot be sold with a trust property the market-exchange is performed to Block 1 and Block 2.

12. The method according to claim 2, wherein if it is determined that Difference 3 cannot be sold with a trust property the market-exchange is performed to Block 1 and Block 2.

13. A computer program product comprising one or more non-transitory computer-readable storage media and program instructions stored at least one of the storage media, the program instructions executable by a processor to cause the processor to perform a method comprising:
a first step of sorting blocks which are generated based on a net buying amount of foreign currency of each user on a reference date in accordance with a predetermined order;
a second step of sorting blocks which are generated based on a net selling amount of foreign currency of each user on the reference date in accordance with a predetermined order;
a third step of determining whether Difference 1 can be sold with a trust property when Sum 1 is greater than Sum 2;
a fourth step of performing a self-exchange to Block 1 and Block 2 if it is determined that Difference 1 can be sold with a trust property;
a fifth step of determining whether Difference 2 can be bought with the trust property; and
a sixth step of performing a market-exchange to Block 1 and performing the self-exchange to Block 2 if it is determined that Difference 2 can be bought with the trust property,
wherein Sum 1 is a total sum of the net buying amount of foreign currency for each user and Sum 2 is a total sum of the net selling amount of foreign currency for each user; Block 2 is the last block among the blocks of the net selling amount of foreign currency and Block 1 is the block of the net buying amount of foreign currency, which overlaps with Block 2; Sum 3 is the sum of the blocks up to Block 1 and Sum 4 is the sum of the blocks which are positioned before Block 1; and Difference 1 is the difference between Sum 3 and Sum 2, and Difference 2 is the difference between Sum 2 and Sum 4.

14. A computer program product comprising one or more non-transitory computer-readable storage media and program instructions stored at least one of the storage media, the program instructions executable by a processor to cause the processor to perform a method comprising:
a first step of sorting blocks which are generated based on a net buying amount of foreign currency of each user on a reference date in accordance with a predetermined order;
a second step of sorting blocks which are generated based on a net selling amount of foreign currency of each user on the reference date in accordance with a predetermined order;
a third step of determining whether Difference 3 can be sold with a trust property when Sum 1 is less than Sum 2;
a fourth step of performing a self-exchange to Block 1 and requesting a market-exchange to Block 2 if it is determined that Difference 3 can be sold with a trust;
a fifth step of determining whether Difference 4 can be bought with the trust property; and
a sixth step of performing the self-exchange to Block 1 and Block 2 if it is determined that Difference 2 can be bought with the trust property,
wherein Sum 1 is a total sum of the net buying amount of foreign currency for each user and Sum 2 is a total sum of the net selling amount of foreign currency for each user; Block 1 is the last block among the blocks of the net buying amount of foreign currency and Block 2 is the block of the net selling amount of foreign currency, which overlaps with Block 1; Sum 5 is the sum of the blocks which are positioned before Block 2 and Sum 6 is the sum of the blocks up to Block 2; and Difference 3 is the difference between Sum 1 and Sum 5, and Difference 4 is the difference between Sum 6 and Sum 1.

15. A computer-implemented system comprising one or more processors and one or more non-transitory computer readable storage media storing computer-executable instructions that, when executed, cause the one or more processors to perform a method comprising:
a first step of sorting blocks which are generated based on a net buying amount of foreign currency of each user on a reference date in accordance with a predetermined order;
a second step of sorting blocks which are generated based on a net selling amount of foreign currency of each user on the reference date in accordance with a predetermined order;
a third step of determining whether Difference 1 can be sold with a trust property when Sum 1 is greater than Sum 2;
a fourth step of performing a self-exchange to Block 1 and Block 2 if it is determined that Difference 1 can be sold with a trust property;
a fifth step of determining whether Difference 2 can be bought with the trust property; and
a sixth step of performing a market-exchange to Block 1 and performing the self-exchange to Block 2 if it is determined that Difference 2 can be bought with the trust property,
wherein Sum 1 is a total sum of the net buying amount of foreign currency for each user and Sum 2 is a total sum of the net selling amount of foreign currency for each user; Block 2 is the last block among the blocks of the net selling amount of foreign currency and Block 1 is the block of the net buying amount of foreign currency, which overlaps with Block 2; Sum 3 is the sum of the blocks up to Block 1 and Sum 4 is the sum of the blocks which are positioned before Block 1; and Difference 1 is the difference between Sum 3 and Sum 2, and Difference 2 is the difference between Sum 2 and Sum 4.

16. A computer-implemented system comprising one or more processors and one or more non-transitory computer readable storage media storing computer-executable instructions that, when executed, cause the one or more processors to perform a method comprising:
a first step of sorting blocks which are generated based on a net buying amount of foreign currency of each user on a reference date in accordance with a predetermined order;
a second step of sorting blocks which are generated based on a net selling amount of foreign currency of each user on the reference date in accordance with a predetermined order;
a third step of determining whether Difference 3 can be sold with a trust property when Sum 1 is less than Sum 2;
a fourth step of performing a self-exchange to Block 1 and requesting a market-exchange to Block 2 if it is determined that Difference 3 can be sold with a trust;
a fifth step of determining whether Difference 4 can be bought with the trust property; and
a sixth step of performing the self-exchange to Block 1 and Block 2 if it is determined that Difference 2 can be bought with the trust property,
wherein Sum 1 is a total sum of the net buying amount of foreign currency for each user and Sum 2 is a total sum of the net selling amount of foreign currency for each user; Block 1 is the last block among the blocks of the net buying amount of foreign currency and Block 2 is the block of the net selling amount of foreign currency, which overlaps with Block 1; Sum 5 is the sum of the blocks which are positioned before Block 2 and Sum 6 is the sum of the blocks up to Block 2; and Difference 3 is the difference between Sum 1 and Sum 5, and Difference 4 is the difference between Sum 6 and Sum 1.
